(19) United States
(12) Patent Application Publication
(10) Pub. No.: US 2026/0047674 A1
(43) Pub. Date: Feb. 19, 2026

(54) TABLE LEG ASSEMBLY AND MOVABLE TABLE

(71) Applicant: Jiawang Mao, Zhongshan (CN)

(72) Inventor: Jiawang Mao, Zhongshan (CN)

(21) Appl. No.: 18/989,602

(22) Filed: Dec. 20, 2024

(30) Foreign Application Priority Data
Aug. 15, 2024 (CN) 2024219831504

(51) Int. Cl. A47B 13/02; B60B 33/00

(52) U.S. Cl. CPC A47B 13/02; B60B 33/0002

(57) ABSTRACT

A table leg assembly, comprising: a base frame and first wheel components, which are mounted to the base frame via auxiliary frames; the auxiliary frame comprises a connecting part connected to the base frame and a mounting part connected to the connecting part and higher than a lower end surface of the base frame; a mounting space corresponding to the first wheel component is formed below the mounting part, and the first wheel component is mounted on the mounting part. Since the mounting part for mounting the first wheel component is higher than a lower end surface of the base frame, the first wheel component can be mounted at a position higher than the lower end surface of the base frame. Compared with the traditional mounting method, more roller mounting space can be obtained, so that shorter table legs can be equipped with larger rollers.

### TECHNICAL FIELD

The invention relates to the technical field of tables, in particular to a table leg assembly and a movable table.

### BACKGROUND ART

The base frame of movable tables such as bedside tables are designed to be partially movable and inserted into a smaller space under a bed or cabinet. In order to make the appearance more concise or reduce the entry of foreign objects into the space under the bed or cabinet, the height of the space under the bed or cabinet is currently designed to be smaller and smaller. Therefore, the height of the base frames/legs of the movable table needs to be designed to be smaller (ultra-low leg structure). Due to insufficient mounting space, only embedded small rollers can be used. The embedded small rollers have a small structure and limited mounting space, and cannot meet the requirements of the brake mechanism. The commonly used large rollers with brakes are generally mounted by passing the base frame from bottom to top through the mounting shaft, that is, the main wheel body is located below the base frame. This will greatly increase the overall height of the table legs and cannot meet the requirements of moving into a smaller space under a bed or cabinet.

### SUMMARY OF THE INVENTION

The invention aims to solve at least one of the technical problems existing in the prior art. To this end, the invention provides a table leg assembly that can meet the mounting requirements of larger rollers in shorter table legs.

The invention further provides a movable table.

According to a first embodiment of the invention, a t able leg assembly, comprising: a base frame and first wheel components, which are mounted to the base frame via auxiliary frames; the auxiliary frame comprises a connecting part connected to the base frame and a mounting part connected to the connecting part and higher than a lower end surface of the base frame; a mounting space corresponding to the first wheel component is formed below the mounting part, and the first wheel component is mounted on the mounting part.

The table leg assembly according to the embodiment of the invention has at least the following beneficial effects: since the mounting part for mounting the first wheel component is higher than a lower end surface of the base frame, the first wheel component can be mounted at a position higher than the lower end surface of the base frame. Compared with the traditional mounting method, more roller mounting space can be obtained, so that shorter table legs can be equipped with larger rollers.

According to an embodiment of the invention, the mounting part is higher than an upper end surface of the base frame.

According to an embodiment of the invention, the table leg assembly further comprises second wheel components, which are mounted to the base frame and an upper end of the second wheel component is no higher than the upper end surface of the base frame.

According to an embodiment of the invention, the lower end surface of the base frame is provided with a groove, and the second wheel component is mounted in the groove and partially protrudes from the lower end surface of the base frame.

According to an embodiment of the invention, the table leg assembly further comprises a column for supporting a table top, and the column is arranged at a rear of the base frame and extends upward; the second wheel component is arranged at a front part of the base frame, and the first wheel component is arranged at a rear part of the base frame.

According to an embodiment of the invention, the connecting part is connected to the mounting part via an extending part, and the extending part extends upward or obliquely upward from the connecting part.

According to an embodiment of the invention, the first wheel component comprises a mounting shaft extending upward, which is connected to the mounting part.

According to an embodiment of the invention, the connecting part is detachably mounted to the base frame.

According to an embodiment of the invention, the base frame is provided with inserting grooves into which the connecting part can be inserted; after the connecting part is inserted into the inserting groove, it can be fixed to the base frame via a fixing mechanism.

According to an embodiment of the invention, the fixing mechanism comprises a fixing screw, and the connecting part and the base frame are provided with holes corresponding to the fixing screw.

According to a second embodiment of the invention, a movable table, comprising the table leg assembly according to any embodiment of the first embodiment of the invention.

The movable table according to the embodiment of the invention has at least the following beneficial effects: it can meet the requirements of the movable table being able to enter and exit a smaller space under a bed or under a cabinet.

### BRIEF DESCRIPTION OF THE DRAWINGS

The above and/or additional aspects and advantages of the invention will become apparent and easily understood from the description of the embodiments with reference to the following drawings, in which:

FIG. 1 is a first schematic diagram of the movable table according to an embodiment of the invention (from an upper perspective);

FIG. 2 is a first exploded schematic diagram of the movable table according to an embodiment of the invention (from an upper perspective);

FIG. 3 is a second schematic diagram of the movable table according to an embodiment of the invention (from a bottom perspective);

FIG. 4 is a second exploded schematic diagram of the movable table according to an embodiment of the invention (from a bottom perspective);

FIG. 5 is a schematic structural diagram of the first wheel component and the auxiliary frame when assembled according to an embodiment of the invention.

In the figures:

100 refers to the base frame; 101 refers to the groove; 102 refers to the inserting groove; 200 refers to the first wheel component; 210 refers to the mounting shaft; 220 refers to the roller body; 230 refers to the rotating frame; 240 refers to the brake control handle; 300 refers to the second wheel component; 400 refers to the auxiliary frame; 410 refers to the connecting part; 411 refers to the fixing screw; 420 refers to the mounting part; 430 refers to the extending part; 900 refers to the table top; 910 refers to the column.

### SPECIFIC EMBODIMENT OF THE INVENTION

The embodiments of the invention will be described in detail hereinafter, and examples of the embodiments are shown in the drawings, wherein the same or similar reference numerals throughout represent the same or similar elements or elements having the same or similar functions. The embodiments described hereinafter with reference to the drawings are exemplary and are only used to explain the invention, and cannot be understood as limiting the invention.

In the description of the invention, it should be understood that descriptions involving orientation, such as up, down, front, back, left, right, etc., indicating orientations or positional relationships, are based on the orientations or positional relationships shown in the drawings, and are only for the convenience of describing the invention and simplifying the description, and do not indicate or imply that the device or element referred to must have a specific orientation, be constructed and operated in a specific orientation, and therefore cannot be understood as a limitation on the invention.

In the description of the invention, if there is a description of first and second, it is only for the purpose of distinguishing the technical features, and cannot be understood as indicating or implying the relative importance or implicitly indicating the number of the indicated technical features or implicitly indicating the order of the indicated technical features.

In the description of the invention, unless otherwise clearly defined, terms such as setting, mounting, connecting, etc. should be understood in a broad sense, and technicians in the relevant technical field can reasonably determine the specific meanings of the above terms in the invention based on the specific content of the technical solution.

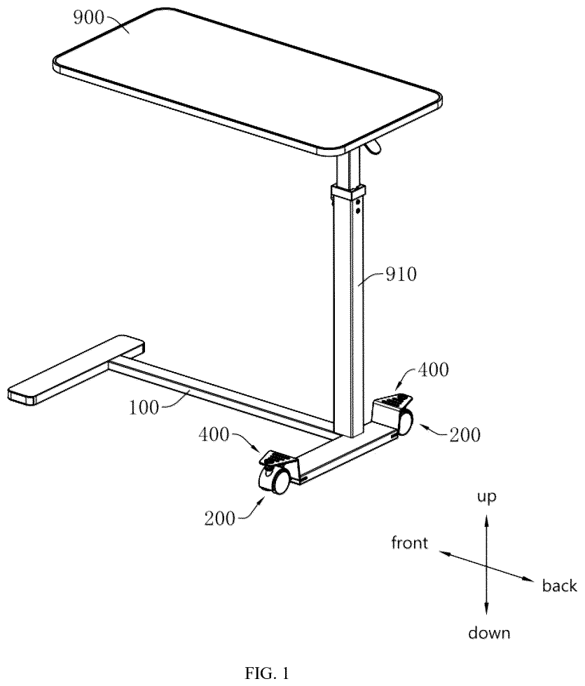

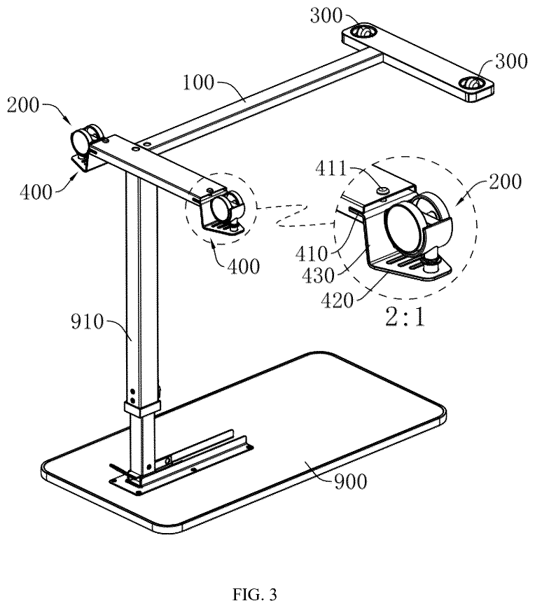

The table leg assembly and the movable table according to the embodiment of the invention will be described hereinafter with reference to FIGS. 1 to 5.

As shown in FIGS. 1-5, the table leg assembly according to the invention, comprising a base frame 100 and first wheel components 200, which are mounted to the base frame 100 via auxiliary frames 400; the auxiliary frame 400 comprises a connecting part 410 connected to the base frame 100 and a mounting part 420 connected to the connecting part 410 and higher than a lower end surface of the base frame 100; a mounting space corresponding to the first wheel component 200 is formed below the mounting part 420, and the first wheel component 200 is mounted on the mounting part 420. Since the mounting part 420 for mounting the first wheel component 200 is higher than the lower end surface of the base frame 100, the first wheel component 200 can be mounted at a position higher than the lower end surface of the base frame 100. Compared with the traditional mounting method, more roller mounting space can be obtained, so that shorter table legs can be equipped with larger rollers.

Specifically, since the mounting part 420 for mounting the first wheel component 200 is higher than the lower end surface of the base frame 100, this is equivalent to the mounting surface of the first wheel component 200 being higher than the traditional roller mounting surface (the lower end surface of the base frame 100). Among the table legs with the same height requirement, since the mounting surface of the first wheel component 200 is higher than the traditional roller mounting surface (the lower end surface of the base frame 100), the first wheel component 200 can adopt larger rollers, such as large rollers with brakes, to facilitate the use of the movable table.

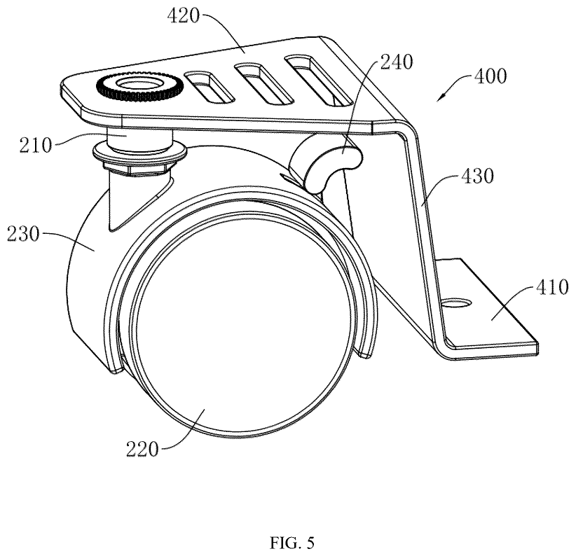

As shown in FIG. 5, in an embodiment of the invention, the first wheel component 200 comprises a mounting shaft 210 extending upward, which is connected to the mounting part 420, thereby meeting the mounting requirements of the first wheel component 200.

Specifically, the mounting shaft 210 can be mounted to the mounting part 420 by means of screwing, riveting, welding, clamping, etc.

As shown in FIG. 5, in an embodiment of the invention, the first wheel component 200 is a roller with a brake mechanism, comprising a roller body 220 and a rotating frame 230. The roller body 220 is rotatably provided on the rotating frame 230. The rotating frame 230 is provided with a brake control handle 240. The brake control handle 240 can lock the roller body 220 through the brake mechanism. The rotating frame 230 is rotatably connected to the mounting shaft 210, so that the first wheel component 200 can rotate in multiple directions and has a braking function to meet different usage requirements.

It can be understood that in an embodiment of the invention, the first wheel component 200 can also be a conventional large roller, such as a roller with better supporting force or a shock-absorbing roller with better use effect, etc., which will not be described in detail here.

As shown in FIG. 1, in an embodiment of the invention, the mounting part 420 is higher than an upper end surface of the base frame 100; that is, the mounting surface of the first wheel component 200 is higher than the upper end surface of the base frame 100, and the base frame 100 can use a first wheel component 200 that is larger than its thickness, that is, the table leg assembly can be equipped with larger rollers.

As shown in FIGS. 1-4, in an embodiment of the invention, the table leg assembly further comprises second wheel components 300, which are mounted to the base frame 100 and an upper end of the second wheel component 300 is no higher than the upper end surface of the base frame 100 to keep the table legs in an ultra-low setting.

Specifically, the second wheel component 300 is a small roller, which will not affect the height of the table legs when mounted and used, so that the overall height of the base frame 100 at the mounting end of the second wheel component 300 is relatively small, which can meet the requirements of entering and exiting a smaller space under a bed or cabinet.

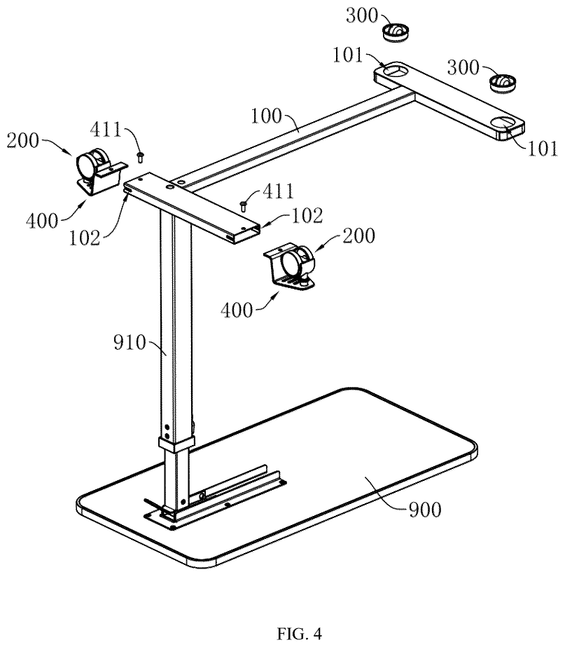

As shown in FIG. 4, in an embodiment of the invention, the lower end surface of the base frame 100 is provided with a groove 101, and the second wheel component 300 is mounted in the groove 101 and partially protrudes from the lower end surface of the base frame 100 to form a roller with an embedded structure.

As shown in FIG. 1, in an embodiment of the invention, the table leg assembly further comprises a column 910 for supporting a table top 900, and the column 910 is arranged at a rear of the base frame 100 and extends upward; the second wheel component 300 is arranged at a front part of the base frame 100, and the first wheel component 200 is arranged at a rear part of the base frame 100, so that the front of the table leg assembly maintains a relatively low structure, making it convenient to enter and exit a smaller space under a bed or cabinet.

Specifically, as shown in FIG. 1, the base frame 100 is a relatively thin I-shaped structure as a whole, the second wheel component 300 is configured as two wings respectively arranged at the front end of the base frame 100 of the I-shaped structure, the first wheel component 200 is configured as two wings respectively arranged at the rear end of the base frame 100 of the I-shaped structure, and the column 910 is arranged at a position close to the rear end of the base frame 100 of the I-shaped structure, so that a larger suspended space is formed below the front of the table top 900. In addition, since the base frame 100 below the front of the table top 900 has a smaller height due to the use of the second wheel component 300, it can meet the requirements of entering and exiting a smaller space under a bed or cabinet.

By configuring the auxiliary frame 400, the mounting requirements of the larger first wheel component 200 can be met without affecting the overall structure of the base frame 100. The base frame 100 can be set as an ultra-thin frame with a constant thickness, which reduces the difficulty of production and processing and has better structural strength.

As shown in FIG. 5, in an embodiment of the invention, the connecting part 410 is connected to the mounting part 420 via an extending part 430, and the extending part 430 extends upward or obliquely upward from the connecting part 410; the mounting part 420 is connected to an upper edge of the extending part 430, thereby forming a mounting space corresponding to the first wheel component 200 below the mounting part 420.

Specifically, the mounting part 420 extends from an upper edge of the extending part 430 in a direction away from the base frame 100, thereby forming a mounting space for the first wheel component 200 on the outside of the base frame 100, without affecting the structure of the base frame 100 or the height of the front end of the base frame 100, thereby maintaining the ultra-low setting of the table legs.

In an embodiment of the invention, the connecting part 410 is detachably mounted to the base frame 100 to facilitate assembly and maintenance of the first wheel component 200.

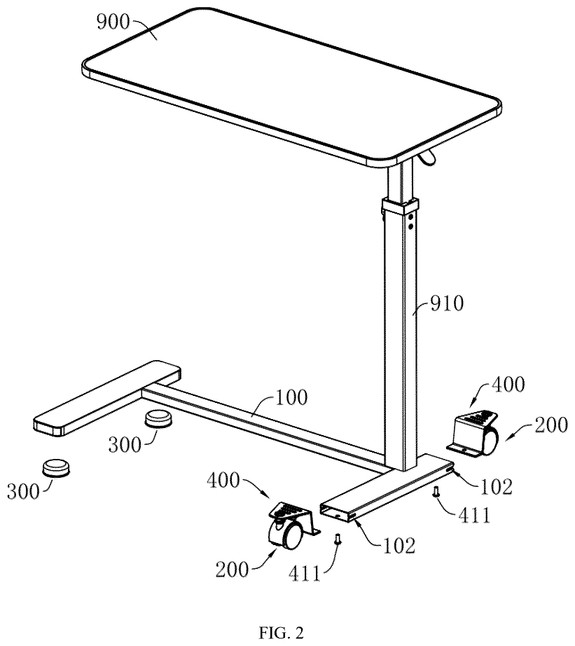

As shown in FIGS. 2, 3, and 4, in an embodiment of the invention, the base frame 100 is provided with inserting grooves 102 into which the connecting part 410 can be inserted; after the connecting part 410 is inserted into the inserting groove 102, it can be fixed to the base frame 100 via a fixing mechanism, which is convenient for assembly and has high stability.

Specifically, the groove 102 is provided at the ends of the two wings at the rear end of the base frame 100 and is open outward. The connecting part 410 of the auxiliary frame 400 is inserted into the groove 102 from the outside of the base frame 100, and then the connecting part 410 is fixed to the base frame 100 by a fixing mechanism such as a latch or a screw. The groove 102 and the connecting part 410 are exactly matched and the connection is compact. In combination with the fixing mechanism, the auxiliary frame 400 can be stably mounted to the base frame 100, thereby improving the stability of the mounting of the first wheel component 200.

As shown in FIGS. 2, 3, and 4, in an embodiment of the invention, the fixing mechanism comprises a fixing screw 411, and the connecting part 410 and the base frame 100 are provided with holes corresponding to the fixing screw 411; the connecting part 410 and the base frame 100 are connected by the fixing screws 411, so as to improve the stability of the mounting of the auxiliary frame 400.

Of course, in the specific implementation process, the fixing mechanism can also be a clamping mechanism, a latch mechanism, etc., which will not be described in detail herein.

As shown in FIGS. 1 to 4, a movable table according to the second aspect of the invention comprises a table leg assembly according to any one of the first aspect of the invention, which can meet the requirements for the movable table to enter and exit a smaller space under a bed or cabinet.

Of course, the invention is not limited to the above implementation modes. Those skilled in the art may make equivalent modifications or substitutions without violating the spirit of the invention. These equivalent modifications or substitutions are all included in the scope defined by the claims of this application.

1. A table leg assembly, comprising:
a base frame;
first wheel components, which are mounted to the base frame via auxiliary frames;
the auxiliary frame comprises a connecting part connected to the base frame and a mounting part connected to the connecting part and higher than a lower end surface of the base frame; a mounting space corresponding to the first wheel component is formed below the mounting part, and the first wheel component is mounted on the mounting part.

2. The table leg assembly of claim 1, wherein:
the mounting part is higher than an upper end surface of the base frame.

3. The table leg assembly of claim 1, wherein:
the table leg assembly further comprises second wheel components, which are mounted to the base frame and an upper end of the second wheel component is no higher than the upper end surface of the base frame.

4. The table leg assembly of claim 3, wherein:
the lower end surface of the base frame is provided with a groove, and the second wheel component is mounted in the groove and partially protrudes from the lower end surface of the base frame.

5. The table leg assembly of claim 3, wherein:
the table leg assembly further comprises a column for supporting a table top, and the column is arranged at a rear of the base frame and extends upward; the second wheel component is arranged at a front part of the base frame, and the first wheel component is arranged at a rear part of the base frame.

6. The table leg assembly of claim 1, wherein:
the connecting part is connected to the mounting part via an extending part, and the extending part extends upward or obliquely upward from the connecting part.

7. The table leg assembly of claim 1, wherein:
the first wheel component comprises a mounting shaft extending upward, which is connected to the mounting part.

8. The table leg assembly of claim 1, wherein:
the base frame is provided with inserting grooves into which the connecting part can be inserted; after the connecting part is inserted into the inserting groove, it can be fixed to the base frame via a fixing mechanism.

9. The table leg assembly of claim 8, wherein:
the fixing mechanism comprises a fixing screw, and the connecting part and the base frame are provided with holes corresponding to the fixing screw.

10. A movable table, comprising the table leg assembly of claim 1.
